(19) United States
(12) Patent Application Publication
(10) Pub. No.: US 2006/0044821 A1
(43) Pub. Date: Mar. 2, 2006

(54) Surface light source device and backlight assembly having the same

(75) Inventors: Ki-Yeon Lee, Suwon-si (KR); Seog-Hyun Cho, Seoul (KR); Kyeong-Taek Jung, Suwon-si (KR); Jae-Hyeon Ko, Suwon-si (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/207,031

(22) Filed: Aug. 19, 2005

(30) Foreign Application Priority Data
Aug. 24, 2004 (KR) 10-2004-66637

(51) Int. Cl. F21V 11/00

(52) U.S. Cl. 362/559; 362/240; 362/260

(57) ABSTRACT

A surface light source device includes a light source body having an internal space into which a discharge gas is injected, and an electrode for applying a voltage to the discharge gas. Partition walls are arranged in the internal space to divide the internal space into a plurality of discharge spaces. To reduce areas of the partition walls, a groove is formed at a side face of each partition wall. Thus, each partition wall has a reduced area so that the partition walls may not act as dark fields of the surface light source device.

### CROSS-REFERENCE TO RELATED APPLICATION

This application claims priority under 35 USC § 119 to Korean Patent Application No. 2004-66637, filed on Aug. 24, 2004, the contents of which are herein incorporated by reference in its entirety for all purposes.

### BACKGROUND OF THE INVENTION

1. Field of the Invention

The present invention relates to a surface light source device and a backlight assembly having the same. More particularly, the present invention relates to a surface light source device for emitting a surface light, and a backlight assembly having the surface light source device as a light source.

2. Description of the Related Art

Generally, a liquid crystal (LC) has specific electrical and optical characteristics. In detail, when electric fields applied to the LC are changed, an arrangement of the LC molecules is also changed. As a result, an optical transmittance is changed.

A liquid crystal display (LCD) apparatus uses the above-explained characteristics of the LC to display an image. The LCD apparatus has many merits, for example, such as a small volume, a lightweight, etc. Therefore, the LCD apparatus is used in various fields, for example, such as a notebook computer, a mobile phone, a television set, etc.

The LCD apparatus requires a liquid crystal controlling part to control the LC and a light providing part to provide the liquid crystal controlling part with a light.

The liquid crystal controlling part includes a pixel electrode formed on a first substrate, a common electrode formed on a second substrate and a liquid crystal layer interposed between the pixel electrode and the common electrode. A number of the pixel electrode is determined in accordance with resolution, and a number of the common electrode is one. Each of the pixel electrodes is electrically connected to a thin film transistor (TFT), so that a pixel voltage is applied to the pixel electrode through the TFT. A reference voltage is applied to the common electrode. Both of the pixel electrode and the common electrode include an electrically conductive and optically transparent material.

The light providing part provides the liquid crystal controlling part with a light. The light generated from the light providing part passes through the pixel electrode, the liquid crystal layer and the common electrode in sequence. Therefore, luminance and uniformity of the luminance have great influence on a display quality of the LCD apparatus.

A conventional light providing part employs a cold cathode fluorescent lamp (CCFL) or a light emitting diode (LED). The CCFL has a long cylindrical shape, and the LED has a small dot shape.

The CCFL has high luminance and long lifespan, and generates small amount of heat. The LED has relatively high power consumption but a better color reproducibility. However, both of the CCFL and the LED have low uniformity of luminance.

Therefore, in order to enhance the luminance uniformity, the light providing part requires optical members such as a light guide plate (LGP), a diffusion member, a prism sheet, etc. As a result, a problem of increase of volume and weight of the LCD apparatus exists.

In order to solve above-mentioned problem, a surface light source device has been developed. The surface light source device may be classified into a partition wall-separated type device and a partition-integrated type device.

FIG. 1 is a plan view illustrating a conventional surface light source device.

Referring to FIG. 1, a conventional surface light source device includes a light source body 1 and electrodes 4. The light source body 1 includes a first substrate (not shown) and a second substrate (not shown) positioned over the first substrate. Partition walls 2 are arranged between the first substrate and the second substrate to form a plurality of discharge spaces 5 into which a discharge gas is injected. A sealing member 3 is interposed between edge portions of the first substrate and the second substrate to isolate the discharge spaces 5 from the exterior. The electrodes 4 are formed on outer faces of the edge portions of the first substrate and the second substrate. Fluorescent layers (not shown) are provided to the first substrate and/or the second substrate.

The partition walls 2 are arranged in a serpentine pattern so that passageways of the discharge gas are formed between the partition walls 2 and the sealing member 3. Here, after the discharge spaces 5 are exhausted, the discharge gas is injected into the discharge spaces 5.

FIG. 2 is a plan view illustrating another conventional surface light source device.

Referring to FIG. 2, a conventional surface light source device includes a light source body 11 and electrodes 14. The light source body 11 includes a first substrate (not shown) and a second substrate (not shown) positioned over the first substrate. Partition walls 12 are arranged between the first substrate and the second substrate to form a plurality of discharge spaces 15 into which a discharge gas is injected. A sealing member 13 is interposed between edge portions of the first substrate and the second substrate to isolate the discharge spaces 15 from the exterior. The electrodes 14 are formed on outer faces of the edge portions of the first substrate and the second substrate. To provide each discharge space 5 with the discharge gas, connection holes 16 are formed through the partition walls 12.

In the above-mentioned conventional surface light source devices, since the partition walls have flat side faces so that the partition walls act as dark fields of the conventional surface light source devices. Thus, to improve luminance of the surface light source devices, decreasing areas of the partition walls, that is, decreasing widths of the partition walls is required.

However, a current drift effect is increased proportional to a decrease of the widths of the partition walls. When a potential difference is generated between adjacent discharge spaces, a current in a discharge space in which a relatively high voltage is generated is drifted into another discharge space in which a relatively low voltage is generated. This phenomenon is referred to as the current drift effect. The current drift effect lowers the luminance uniformity of the surface light source device. There is a limit to reduce the area of the partition wall by narrowing the width of the partition wall having the flat side faces.

Therefore, to suppress the generation of the dark field due to the partition wall, a diffusion plate is positioned over the surface light source device by a maximum distance. This increases a thickness of a display apparatus such as an LCD TV that has the surface light source device as a light source.

### SUMMARY OF THE INVENTION

The present invention provides a surface light source device that is capable of suppressing generations of dark fields due to partition walls.

The present invention also provides a backlight assembly having the above-mentioned surface light source device as a light source.

A surface light source device in accordance with one aspect of the present invention includes a light source body having an internal space into which a discharge gas is injected, and an electrode for applying a voltage to the discharge gas. Partition walls are arranged in the internal space to divide the internal space into a plurality of discharge spaces. To reduce areas of the partition walls, a groove is formed at a side face of each partition wall.

According to one embodiment, the groove may have trapezoid shape, a triangular shape, a semi-circular shape, etc. The groove may be formed at both sides of each partition wall.

A backlight assembly in accordance with another aspect of the present invention includes a surface light source device, a case for receiving the surface light source device, an optical sheet interposed between the surface light source device and the case, and an inverter for applying a discharge voltage to the surface light source device. The surface light source device includes a light source body having an internal space into which a discharge gas is injected, partition walls arranged in the internal space to divide the internal space into a plurality of discharge spaces and having a groove formed at a side face of each partition wall, and an electrode for applying a voltage to the discharge gas.

According to the present invention, the groove is formed at the side face of each partition wall so that each partition wall has a reduced area. Thus, the partition walls may not act as dark fields of the surface light source device. As a result, the surface light source device may have improved luminance.

### BRIEF DESCRIPTION OF THE DRAWINGS

The above and other features and advantages of the present invention will become more apparent by describing in detailed exemplary embodiments thereof with reference to the accompanying drawings, in which:

FIGS. 1 and 2 are plan views illustrating conventional surface light source devices;

FIG. 3 is a perspective view illustrating a surface light source device in accordance with a fist embodiment of the present invention;

FIG. 4 is a plan view illustrating the surface light source device in FIG. 3;

FIG. 5 is a plan view illustrating a surface light source device in accordance with a second embodiment of the present invention;

FIG. 6 is a plan view illustrating a surface light source device in accordance with a third embodiment of the present invention;

FIG. 7 is a plan view illustrating a surface light source device in accordance with a fourth embodiment of the present invention;

FIG. 8 is a plan view illustrating a surface light source device in accordance with a fifth embodiment of the present invention;

FIG. 9 is a plan view illustrating a surface light source device in accordance with a sixth embodiment of the present invention; and

FIG. 10 is an exploded perspective view illustrating a back light unit having the surface light source device in FIG. 3 in accordance with a seventh embodiment of the present invention.

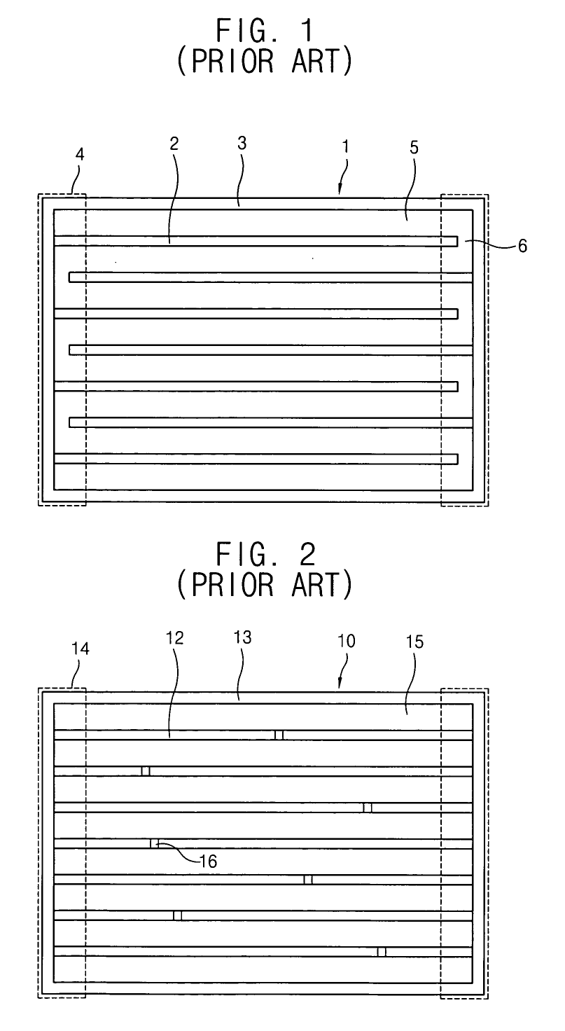

### DESCRIPTION OF EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of elements and regions may be exaggerated for clarity.

It will be understood that when an element or layer is referred to as being “on”, “connected to” or “coupled to” another element, it can be directly on, connected or coupled to the other element or layer or intervening elements may be present. In contrast, when an element is referred to as being “directly on,” “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Embodiment 1

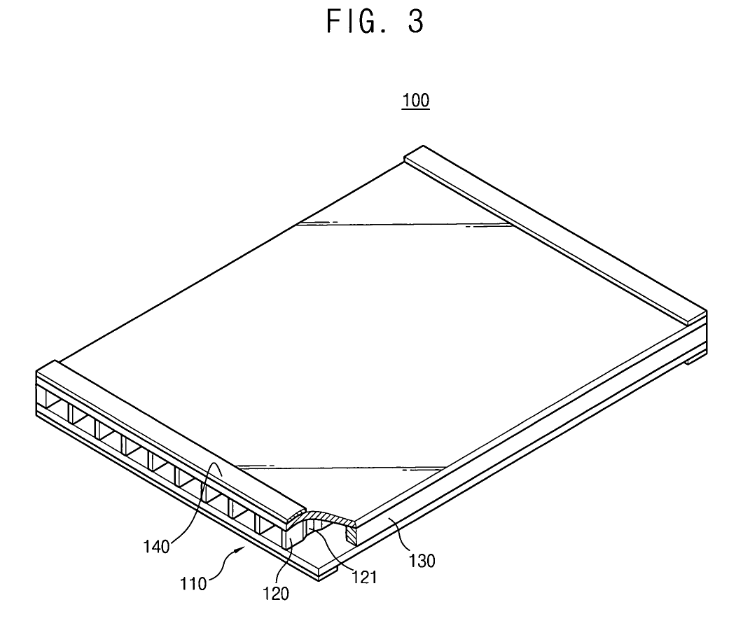

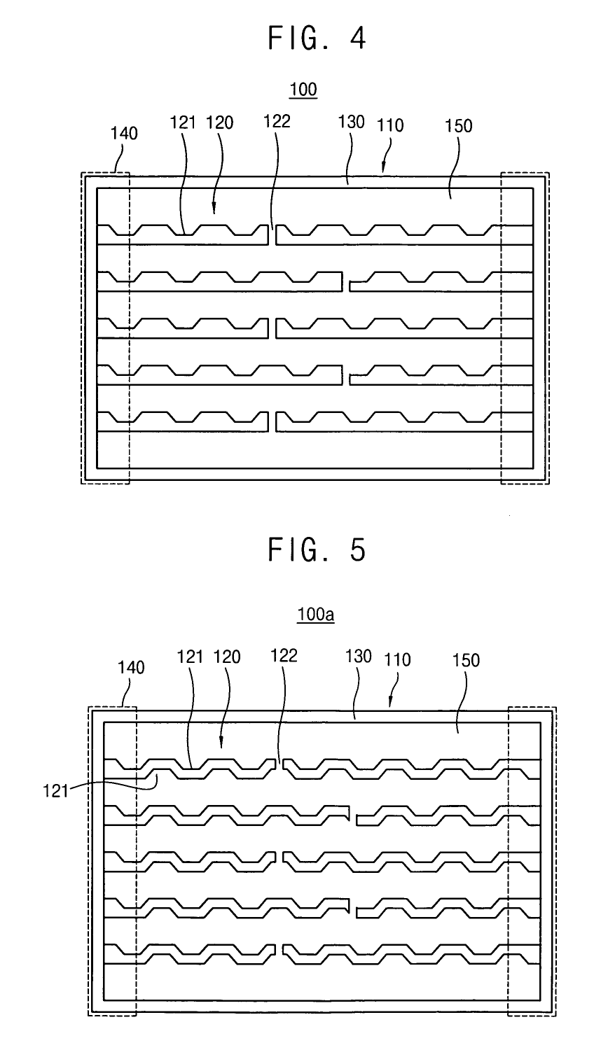

FIG. 3 is a perspective view illustrating a surface light source device in accordance with a fist embodiment of the present invention, and FIG. 4 is a plan view illustrating the surface light source device in FIG. 3.

Referring to FIGS. 3 and 4, a surface light source device 100 in accordance with the present embodiment includes a body 110 having an internal space into which a discharge gas is injected, and an electrode 140 for supplying a discharge voltage to the discharge gas. Examples of the discharge gas include a mercury gas, an argon gas, a neon gas, a xenon gas, etc. These can be used alone or in a combination thereof.

The body 110 includes a first substrate (not shown), a second substrate (not shown) positioned over the first substrate. The first and second substrates include a glass that is capable of transmitting a visible light therethrough and blocking an ultraviolet ray. The second substrate corresponds to a light-exiting face through which a light generated in the internal space exits.

Partition walls 120 are arranged in the internal space to divide the internal space into a plurality of discharge spaces 150. The partition walls 120 are arranged in a first direction. In the present embodiment, the partition walls 120 are separated from the second substrate. Thus, a sealing member 130 is positioned between edges of the first and second substrates to define the internal space. Alternatively, the partition walls 120 may be integrally formed with the second substrate. Thus, outermost partition walls 120 among the partition walls 120 are attached to the first substrate to form the discharge spaces 150.

Each partition wall 120 has side faces orienting in a second direction substantially perpendicular to the first direction. Grooves 121 are formed at a side face of each partition wall 120. The grooves 121 serves as to reduce an area of each partition wall 120. In the present embodiment, the grooves 121 have a trapezoid shape. That is, although each partition wall 120 has a non-narrowed width, the area of each partition wall 120 is decreased as much as an area of the grooves 121. Thus, generation of dark fields due to the partition walls 120 may be suppressed.

Meanwhile, in the present embodiment, to provide the discharge spaces 150 with the discharge gas, connection holes 122 are irregularly formed through the partition walls 120. Alternatively, the partition walls 122 may be arranged in a serpentine pattern to form alternate passageways between the partition walls 122 and the sealing member 130.

### Embodiment 2

FIG. 5 is a plan view illustrating a surface light source device in accordance with a second embodiment of the present invention.

A surface light source device 100a of the present embodiment includes elements substantially identical to those in Embodiment 1 except for grooves. Thus, same reference numerals refer to same elements and any further illustrations with respect to the same elements are omitted herein.

Referring to FIG. 5, the trapezoid grooves 121 are formed at both sides of each partition wall 120, respectively. In particular, the trapezoid grooves 121 are arranged in a zigzag pattern to still more reduce the area of each partition wall 120.

### Embodiment 3

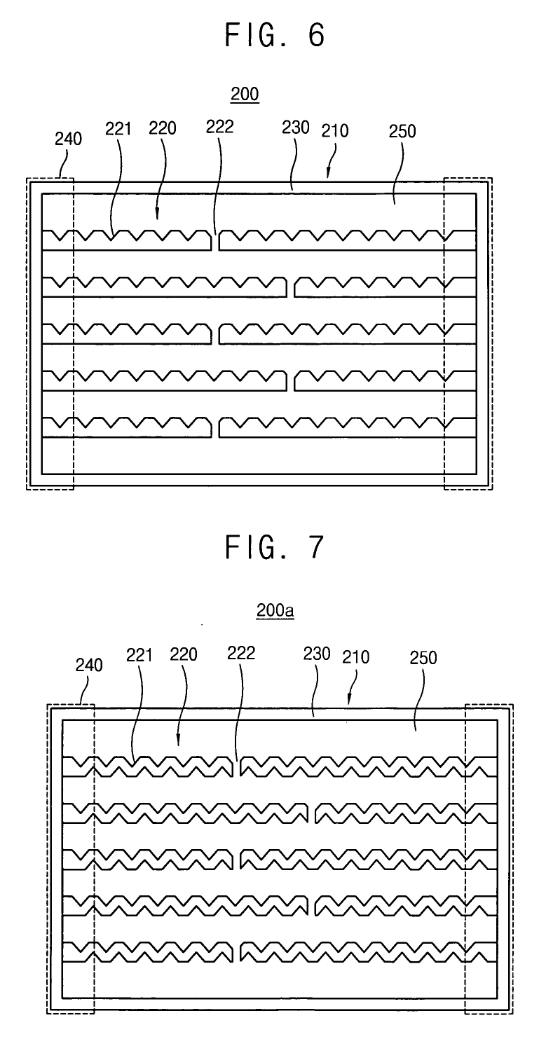

FIG. 6 is a plan view illustrating a surface light source device in accordance with a third embodiment of the present invention.

Referring to FIG. 6, a surface light source device 200 in accordance with the present embodiment includes a body 210 having an internal space into which a discharge gas is injected, and an electrode 240 for supplying a discharge voltage to the discharge gas. The body 210 includes a first substrate (not shown), a second substrate (not shown) positioned over the first substrate. Partition walls 220 are arranged in the internal space to divide the internal space into a plurality of discharge spaces 250. A sealing member 230 is positioned between edges of the first and second substrates to define the internal space. Grooves 221 are formed at a side face of each partition wall 220. In the present embodiment, the grooves 221 have a triangular shape. Connection holes 222 are formed through each partition wall 220.

### Embodiment 4

FIG. 7 is a plan view illustrating a surface light source device in accordance with a fourth embodiment of the present invention.

A surface light source device 200a of the present embodiment includes elements substantially identical to those in Embodiment 3 except for grooves. Thus, same reference numerals refer to same elements and any further illustrations with respect to the same elements are omitted herein.

Referring to FIG. 7, the triangular grooves 221 are formed at both sides of each partition wall 220, respectively. In particular, the triangular grooves 221 are arranged in a zigzag pattern.

### Embodiment 5

FIG. 8 is a plan view illustrating a surface light source device in accordance with a fifth embodiment of the present invention.

Referring to FIG. 8, a surface light source device 300 in accordance with the present embodiment includes a body 310 having an internal space into which a discharge gas is injected, and an electrode 340 for supplying a discharge voltage to the discharge gas. The body 310 includes a first substrate (not shown), a second substrate (not shown) positioned over the first substrate. Partition walls 320 are arranged in the internal space to divide the internal space into a plurality of discharge spaces 350. A sealing member 330 is positioned between edges of the first and second substrates to define the internal space. Grooves 321 are formed at a side face of each partition wall 320. In the present embodiment, the grooves 321 have a semi-circular shape. Connection holes 322 are formed through each partition wall 320.

### Embodiment 6

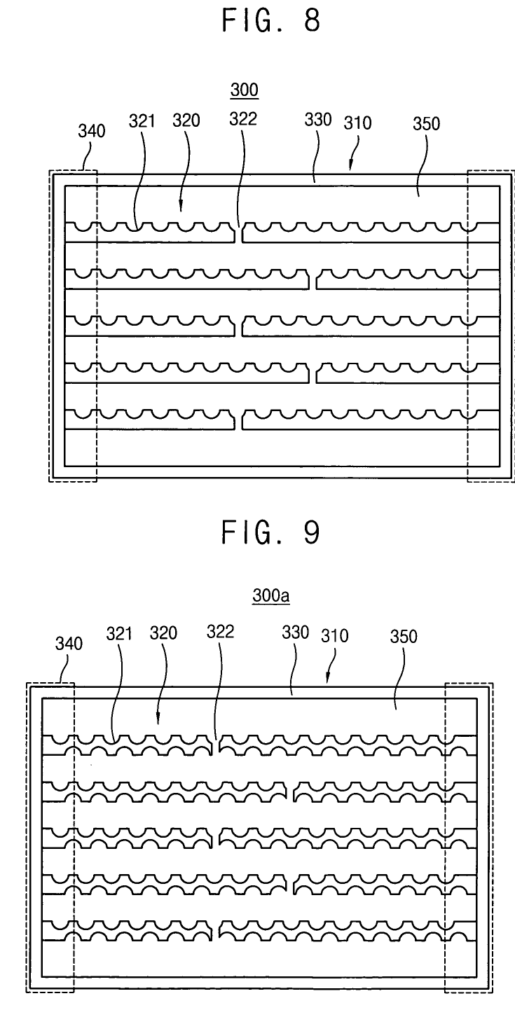

FIG. 9 is a plan view illustrating a surface light source device in accordance with a sixth embodiment of the present invention.

A surface light source device 300a of the present embodiment includes elements substantially identical to those in Embodiment 5 except for grooves. Thus, same reference numerals refer to same elements and any further illustrations with respect to the same elements are omitted herein.

Referring to FIG. 9, the semi-circular grooves 321 are formed at both sides of each partition wall 320, respectively. In particular, the semi-circular grooves 321 are arranged in a zigzag pattern.

### Embodiment 7

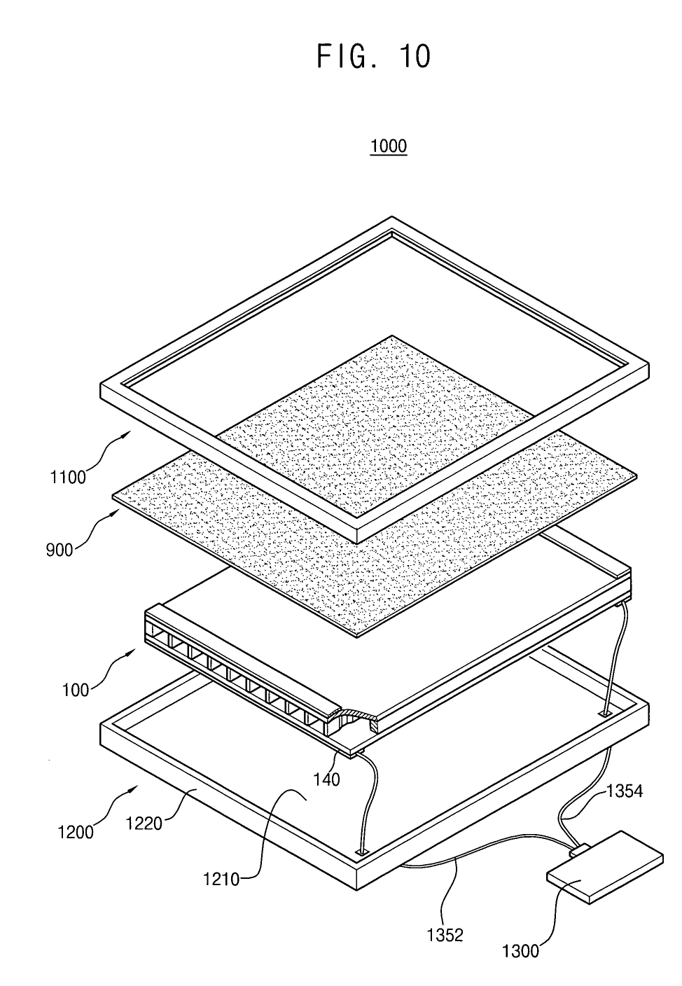

FIG. 10 is an exploded perspective view illustrating a backlight assembly having the surface light source device in FIG. 3 in accordance with a seventh embodiment of the present invention.

Referring to FIG. 10, a backlight assembly 1000 in accordance with the present embodiment includes the surface light source device 100 in FIG. 3, upper and lower cases 1100 and 1200, an optical member 900 and an inverter 1300.

The surface light source device 100 is illustrated in detail with reference to FIG. 3. Thus, any further illustrations of the surface light source device 100 are omitted. Alternatively, other surface light source devices in accordance with Embodiments 2 and 6 may be employed in the backlight assembly 1000.

The lower case 1200 includes a bottom face 1210 for receiving the surface light source device 100, and a side face 1220 extending from an edge of the bottom face 1210. Thus, a receiving space for receiving the surface light source device 100 is formed in the lower case 1200.

The inverter 1300 is arranged under the lower case 1200. The inverter 1300 generates a discharge voltage for driving the surface light source device 100. The discharge voltage generated from the inverter 1300 is applied to the electrode 140 of the surface light source device 100 through first and second electrical cables 1352 and 1354.

The optical member 900 includes a diffusion sheet (not shown) for uniformly diffusing a light irradiated from the surface light source device 100, and a prism sheet (not shown) for providing straightforwardness to the light diffused by the diffusion sheet.

The upper case 1100 is combined with the lower case 1220 to support the surface light source device 100 and the optical member 900. The upper case 1100 prevents the surface light source device 100 from being separated from the lower case 1200.

Additionally, an LCD panel (not shown) for displaying an image may be arranged over the upper case 1100.

According to the present invention, the groove is formed at the side face of each partition wall so that the each partition wall has a reduced area. Thus, the partition walls may not act as dark fields of the surface light source device.

As a result, a diffusing plate may be positioned adjacent to the surface light source device so that a display apparatus having the surface light source device may have a thin thickness.

Having described the exemplary embodiments of the present invention and its advantages, it is noted that various changes, substitutions and alterations can be made herein without departing from the spirit and scope of the invention as defined by appended claims.

What is claimed is:

1. A surface light source device comprising:
a light source body having an internal space into which a discharge gas is injected;
partition walls arranged in the internal space to divide the internal space into a plurality of discharge spaces, the partition walls having a groove that is formed at a side face of each of the partition walls; and
an electrode for applying a voltage to the discharge gas.

2. The surface light source device of claim 1, wherein the light source body comprises:
a first substrate;
a second substrate positioned over the first substrate; and
a sealing member interposed between edge portions of the first and second substrates.

3. The surface light source device of claim 1, wherein the light source body comprises:
a first substrate; and
a second substrate positioned over the first substrate, the second substrate being integrally formed with the partition walls.

4. The surface light source device of claim 1, wherein the grooves are formed at both side faces of each partition wall, respectively.

5. The surface light source device of claim 4, wherein the grooves are arranged in a zigzag pattern at the both side faces of each partition wall, respectively.

6. The surface light source device of claim 1, wherein the groove has a trapezoid shape, a triangular shape or a semi-circular shape.

7. A backlight assembly comprising:
a surface light source device including a light source body that has an internal space into which a discharge gas is injected, partition walls that are arranged in the internal space to divide the internal space into a plurality of discharge spaces and has a groove formed at a side face of each of the partition walls, and an electrode for applying a voltage to the discharge gas;
a case for receiving the surface light source device;
an optical member interposed between the surface light source device and the case; and
an inverter for applying a discharge voltage to the electrode of the surface light source device.
